(19) United States
(12) Patent Application Publication
(10) Pub. No.: US 2017/0203430 A1
(43) Pub. Date: Jul. 20, 2017

(54) HANDLE FOR BROOM OR OTHER TOOL

(71) Applicant: Erwin Tomm, Cleveland, OH (US)

(72) Inventor: Erwin Tomm, Cleveland, OH (US)

(21) Appl. No.: 15/409,054

(22) Filed: Jan. 18, 2017

Related U.S. Application Data
(60) Provisional application No. 62/280,689, filed on Jan. 19, 2016.

(51) Int. Cl. B25G 1/10; A46B 9/02; B25G 3/30

(52) U.S. Cl. CPC B25G 1/102; B25G 3/30; A46B 9/02; A46B 2200/302

(57) ABSTRACT

A handle for a push broom or other janitorial tool includes an elongated body with opposite first and second ends. The body includes a polymeric structure including a core that extends along a longitudinal axis. The body includes a plurality of arms that extend radially outward from the core. Each of the arms includes an inner end connected to the core and an outer end including an enlarged head with an outer surface for being gripped by a user. The outer surfaces of the arms together define a gripping surface. Each circumferentially successive pair of arms is circumferentially spaced-apart from each other by an open channel that extends parallel to the longitudinal axis. Each of the open channels includes a space defined between the circumferentially successive pair of arms and includes a gap in communication with the space and that separates circumferentially successive enlarged heads from each other such that the gap interrupts said gripping surface.

### CROSS-REFERENCE TO RELATED APPLICATION

This application claims priority from and benefit of the filing date of U.S. provisional patent application Ser. No. 62/280,689 filed Jan. 19, 2016, and the entire disclosure of said provisional application is hereby expressly incorporated by reference in to the present specification.

### BACKGROUND

Push brooms are well-known and in widespread use. Push brooms include a push broom head made from wood or a solid block of molded polymeric material that extends laterally and includes a multitude of broom bristles that are affixed to the lower surface thereof. The upper surface or upper side of the push broom head, on the side oriented away from the surface being swept, includes at least one threaded bore or female socket. An elongated broom handle includes a threaded male connector that is mated with the female socket of the push broom head. A user grasps the handle and moves the broom across a floor or other surface to be swept such that the bristles sweep the floor or other surface.

Known push broom handles have sometimes been deemed unsuitable for use in certain institutional environment or other controlled locations such as prisons or mental health facilities because a solid wooden handle can be sharpened and/or otherwise used as a weapon. Known hollow, tubular plastic or metal handles have also been found to pose a risk in that the hollow space inside the handle can be used to conceal contraband such as weapons, liquids, or other contraband. Known handles are sufficiently rigid to be used as an effective weapon.

In light of the foregoing, a need has been identified for a new and improved handle for a push broom, mop, janitorial tool, or other tool that is suitable for use in prisons and other institutional and controlled environments where increased safety is important.

### SUMMARY OF THE PRESENT DEVELOPMENT

A handle for a push broom or other janitorial tool includes an elongated body with opposite first and second ends. The body includes a polymeric structure including a core that extends along a longitudinal axis. The body includes a plurality of arms that extend radially outward from the core. Each of the arms includes an inner end connected to the core and an outer end including an enlarged head with an outer surface for being gripped by a user. The outer surfaces of the arms together define a gripping surface. Each circumferentially successive pair of arms is circumferentially spaced-apart from each other by an open channel that extends parallel to the longitudinal axis. Each of the open channels includes a space defined between the circumferentially successive pair of arms and includes a gap in communication with the space and that separates circumferentially successive enlarged heads from each other such that the gap interrupts said gripping surface.

### BRIEF DESCRIPTION OF THE DRAWINGS

FIGS. 1 and 2 are respective isometric views of a push broom including a handle formed in accordance with the present development (the handle is only partially shown in FIG. 1);

FIG. 2A is an isometric view of detail section 2A of the handle of FIG. 2;

FIG. 2B is a greatly enlarged section view of a handle formed in accordance with the present development as taken along line B-B of FIG. 2A;

FIG. 3A is a side view of a polymeric hand grip portion of the handle of FIG. 2;

FIG. 3B is a section view of the hand grip of FIG. 3A as taken at B-B of FIG. 3A.

### DETAILED DESCRIPTION OF PRESENT DEVELOPMENT

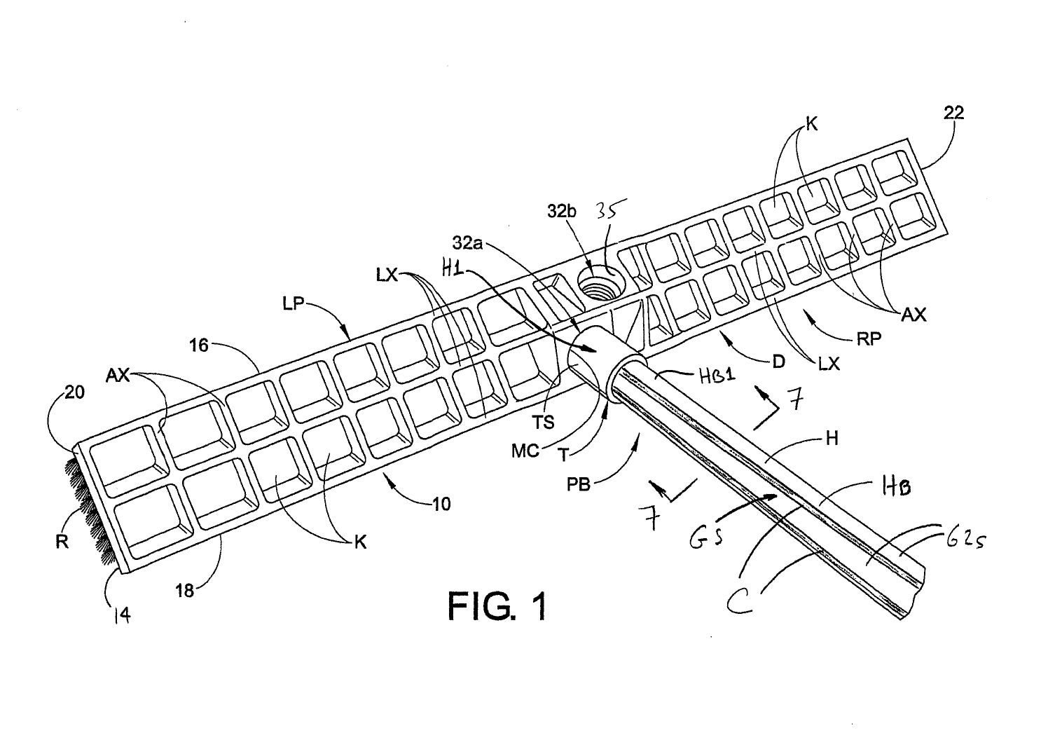

The present development relates to a handle for a push broom, mop, or other tool or janitorial tool, and to a push broom or other tool including such a handle as described herein with reference to FIGS. 1-3B. With reference to FIGS. 1 & 2, a push broom PB includes a head D and an elongated handle H that is operably connected to the head D such that a user can grasp the handle H to move the push broom head D across the floor or other surface being swept in order to perform sweeping. The push broom PB is only one non-limiting example of a janitorial or other tool that can be connected to the handle H for performing cleaning or other work, and it is not intended that the present development be limited to a push broom or any other particular tool connected to the handle H.

The handle H includes an elongated body or body portion HB that extends outwardly away from the head D. The handle body HB includes a first end or inner end HB1 and a second or outer end HB2, and the inner and outer ends HB1,HB2 of the handle body are respectively located at the first or inner and second or outer ends H1,H2 of the handle H. The inner end of the handle includes a tip T that is defined as a one-piece polymeric construction or other structure that is affixed to the body portion HB of the handle H. The tip T comprises an externally threaded male connector MC portion that is engaged with a mating internally threaded socket located in the push broom head D and also comprises a cylindrical outer surface TS that defines an outside diameter. One example of a suitable handle tip T is disclosed in commonly owned U.S. Pat. No. 7,798,755. In the present example, the base 12 of the connector 10 shown in U.S. Pat. No. 7,798,755 provides the present cylindrical outer surface TS and the threaded male portion 20 of the connector 10 shown in U.S. Pat. No. 7,798,755 provides the present threaded male connector portion MC, but other handle and tip structures are contemplated and fall within the scope of the present development. The tip is preferably glued or otherwise permanently adhered to the inner end of the handle to prevent or inhibit removal of the tip T from the handle H. For added institutional safety, the tip T is preferably defined from a suitable soft, low-density “shank-free” polymer such as polyurethane that resists formation into a sharp instrument or “shank” if sanded, abraded or otherwise mechanically shaped.

The illustrated push broom head D is only one example of a push broom head that can be used with a handle H formed according to the present development. The push broom head D can alternatively comprise any known push broom head comprising a body made from wood, polymeric material, metal and/or any other suitable material and comprising bristles or a cleaning pad or other cleaning structure connected to the body, and it is not intended that the present development be limited to any particular push broom head. The illustrated push broom head D comprises a laterally extending elongated body 10 that extends perpendicularly to the longitudinal axis X of the handle H and that is defined as a one-piece polymeric structure, such as a one-piece injection molded or other polymeric structure. The body 10 includes an upper face 12, a lower face 14, a front face 16, a rear face 18, and opposite left (first) and right (second) end faces 20,22. In the illustrated embodiment, which is not intended to be limiting, the head D defines a rectangular shape.

The lower face 14 of the push broom includes a plurality of polymeric, natural, and/or other type of sweeper bristles R affixed thereto by any known suitable means such as adhesive, polymeric welding, staples or other fasteners, or any other suitable convenient means such that the sweeper bristles project outwardly relative to the lower face 14.

The body 10 of the push broom head D includes a handle mounting block 30 that projects outwardly or upwardly from the upper surface 12 of the body 10 and that is located adjacent the upper face 12, generally at the midpoint between the left and right end surfaces 20,22. The handle mounting block 30 includes at least a first internally threaded handle mounting socket or bore 32a defined therein and adapted to receive and threadably mate with the externally threaded male connector portion MC of the tip T of the handle H. The central axis of the first handle mounting socket 32a is located in a plane that lies perpendicular to the front and rear faces 16,18 and that is oriented normal to the upper surface 12, but the central axis of the first handle mounting socket 32a is offset by about +35 degrees to about +45 degrees (e.g. +45 degrees) relative to a position where it would also lie normal to the upper surface 12 so that it opens toward the rear surface 18 of the head 10. In one preferred embodiment, the handle mounting block 30 comprises both first and second handle mounting sockets 32a,32b including the first handle mounting socket 32a and also a second identical handle mounting socket 32b oriented in the opposite direction as compared to the first socket 32a. The central axis of the second handle mounting socket 32b is located in a plane that lies perpendicular to the front and rear faces 16,18 and that is oriented normal to the upper surface 12, but the central axis of the second handle mounting socket 32b is offset by about −35 degrees to about −45 degrees (e.g. −45 degrees) relative to a position where it would also lie normal to the upper surface 12 so that it opens toward the front surface 16 of the push broom head 10 in an opposite direction as compared to the first socket 32a. The first and second handle mounting sockets 32a,32b are laterally offset from each other. Each of the first and second sockets includes a counterbore 35 at its outermost end, and the counterbore 35 is dimensioned to receive the cylindrical outer surface TS of the handle tip T with a tight, friction-fit that inhibits rotation of the handle tip T to minimize the tendency of the handle to become loose during use, i.e., the friction fit between the cylindrical outer surface TS and the mounting block 30 in the counterbore 35 inhibits loosening of the handle H.

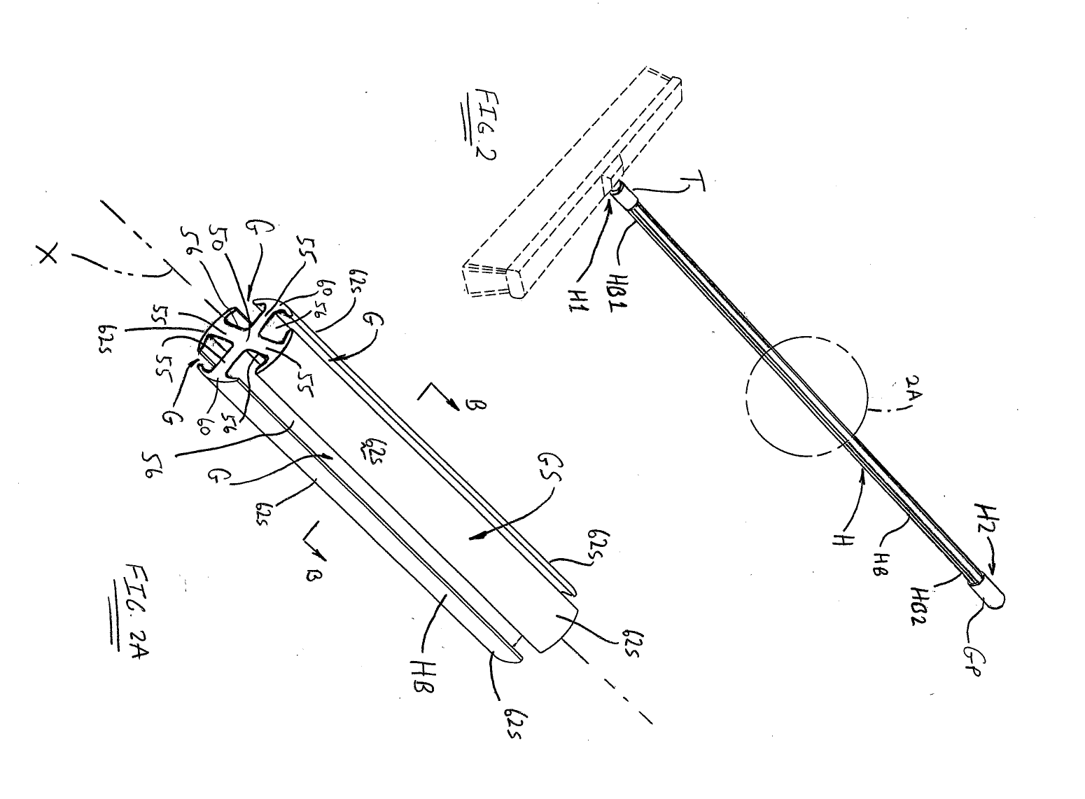

According to the present development, a new and improved handle H is provided. FIG. 2 is an isometric view of a push broom including a handle formed in accordance with the present development. FIG. 2A provides an isometric view of detail section 2A of the handle of FIG. 2. FIG. 2B is a greatly enlarged section view of a handle formed in accordance with the present development as taken along line B-B of FIG. 2A. The handle H comprises a one-piece handle body HB defined from a polymeric material such as ABS (acrylonitrile butadiene styrene) or other suitable polymeric material. The handle body is preferably formed by an extrusion process so that the handle body HB comprises a monolithic or one-piece extruded structure that comprises and is defined by a cross-section or profile that extends continuously and uniformly about a central longitudinal axis X along an entire length of the handle H. FIG. 2B shows one example of a suitable extrusion profile of the handle body HB. Alternatively, the handle body HB comprises a one-piece injection molded or otherwise formed polymeric structure having a cross-section profile as shown in FIG. 2B and/or as otherwise described herein.

The handle body HB is preferably defined symmetrically about the linear longitudinal axis X. The handle body HB includes a central core 50 that extends continuously and uniformly along the longitudinal axis X. The core 50 is preferably solid as shown to eliminate a hollow channel or void that can be used to conceal contraband.

The handle body HB further comprises a plurality of arms 55 that extend radially outward or otherwise extend outwardly from the core. In the illustrated embodiment, the preferred four arms 55a-55d are illustrated, and the arms 55 extend linearly or radially outward from the core and are uniformly, symmetrically, circumferentially or angularly spaced apart from each other in 90 degree increments so as to form or define a cross-shaped or X-shaped profile.

Each arm 55 includes a shaft 56, and an inner or proximal end PE of each arm 55 and arm shaft 56 is connected to the core 50 and the outer or distal end DE of each arm 55 and arm shaft 56 is spaced radially outward from the core 50. As shown herein, the core 50 is defined by the intersecting inner ends PE of the arm shafts 56. The distal end DE of each arm shaft 56 is enlarged and comprises an enlarged head 60 comprising an outer surface 62s for being gripped by a user. In one example, the head 60 extends symmetrically outward in first and second opposite lateral directions relative to the distal end DE of the respective arm shaft 56 to which it is attached, and the outer surface 62s of each head 60 comprises a convexly curved surface, a plurality of convexly curved surfaces, a plurality of flat or planar surfaces, and/or a combination of curved and flat surfaces or other surfaces that together define the outer surface 62s to have a convexly curved, convexly contoured or other convex shape that extends circumferentially about the core 50. Each arm shaft 56 and head 60 define a T-shaped structure. In one embodiment, each outer surface 62s comprises a single arcuate surface defined by an arc segment centered at the longitudinal axis X. The outer surfaces 62s of the respective arms 55 all taken together define an outer gripping surface GS of the handle body HB. FIG. 6B shows that each head 60 further comprises two (first and second) connecting surfaces 62t located on opposite sides of the arm shaft 56 that connect the outer or distal end DE of the arm shaft 56 to opposite circumferential ends of the outer surface 62s.

The arms 55 (and arm shafts 56) are circumferentially spaced-apart from each other such that an open groove or space S is defined between each circumferentially successive pair of arms 55 and arm shafts 56. The outer surfaces 62s of the respective heads 60 are also circumferentially separated from each other by channels or gaps G that open respectively into and communicate with the spaces S, i.e., the gaps G separate circumferentially successive heads 60 from each other, and the gaps G thus separate circumferentially successive outer surfaces 62s from each other. As such, each spaces S and the gap G in communication therewith cooperate to define an open channel C comprising a closed inner end C1 defined by and between the core 50 and two arms 55, and comprising an open outer end C2 defined by the gap G separating the respective outer surfaces 62s. The open outer end C2 of each channel C is partially defined by the opposed spaced-apart facing portions of the respective connecting surfaces 62t of circumferentially successive heads 60. Each open channel C extends parallel to the longitudinal axis X for the entire length of the handle body HB. Each channel C opens through the gripping surface GS for the entire length of the channel C and handle body HB, and the gap G of each channel C is sufficiently large and open so that any object or contraband located in the channel C can be visualized by a guard or other human observer through the gaps G. In other words, each gap G opens through the gripping surface GS and circumferentially interrupts the gripping surface GS. In one non-limiting example, the handle body HB defines a 1 inch outside diameter, and each gap G is gap is 0.10 inch to 0.20 inch (2.54 mm-5.1 mm) minimum, but it is not intended that the present development be limited to this or any other particular dimension. The illustrated example shows four radial arms 55, but more or less arms 55, such as three, five, or more arms 55, can be used without departing from the overall scope and intent of the present development. The maximum angular dimension of each gap G is less than the maximum angular spacing between circumferentially successive arm shafts 56 such that the gaps G are small enough so as not to interrupt the gripping surface GS more than necessary to allow visual sight access into the spaces S in communication with the respective gaps G.

Accordingly, each circumferentially successive pair of arms 55 is circumferentially spaced-apart from each other by an open channel C that extends parallel to the longitudinal axis X, and each of the open channels C comprises a space S defined between said circumferentially successive pair of arms 55 and further comprises a gap G in communication with the space S that separates circumferentially successive enlarged heads 60 from each other and that separates circumferentially successive outer surfaces 62s from each other. The presence of the open channels C that extend parallel to the longitudinal axis X for the entire length of the handle body HB provides the handle body HB with a resilient structure that resiliently bends or flexes along its length such that the longitudinal axis X can be resiliently curved in a reference plane, and the radial arms 55 of the handle body HB also resiliently accommodates torsional flexing of the handle body HB about the longitudinal axis X. This resilient flexing and torsion of the handle body HB reduces the effectiveness of the handle as a weapon in terms of impact and aim to reduce the risk of serious injury. In case a user attempts to use the push broom PB and/or handle H as a weapon, the push broom PB and handle H will flex, wobble, and twist sufficiently to reduce the effectiveness of the broom PB and/or handle H as a weapon. On the other hand, the core 50 and radial arms 55 are highly effective at transmitting forces axially along and parallel to the longitudinal axis X as required to sweep or perform other work. As shown in FIG. 2B, the handle body HB defines a maximum radius R measured radially between the longitudinal axis X and the outer surface 62s of an enlarged head 60, and each arm 55 defines a maximum free length FL measured between the location where the arm shaft 56 connects with the core 50 and the outer surface 62s of the enlarged head 60, and the free length FL is preferably at least 50% of the radius R and most preferably at least 67% of the radius R to provide the handle body HB with the required flexibility and other characteristics as described herein.

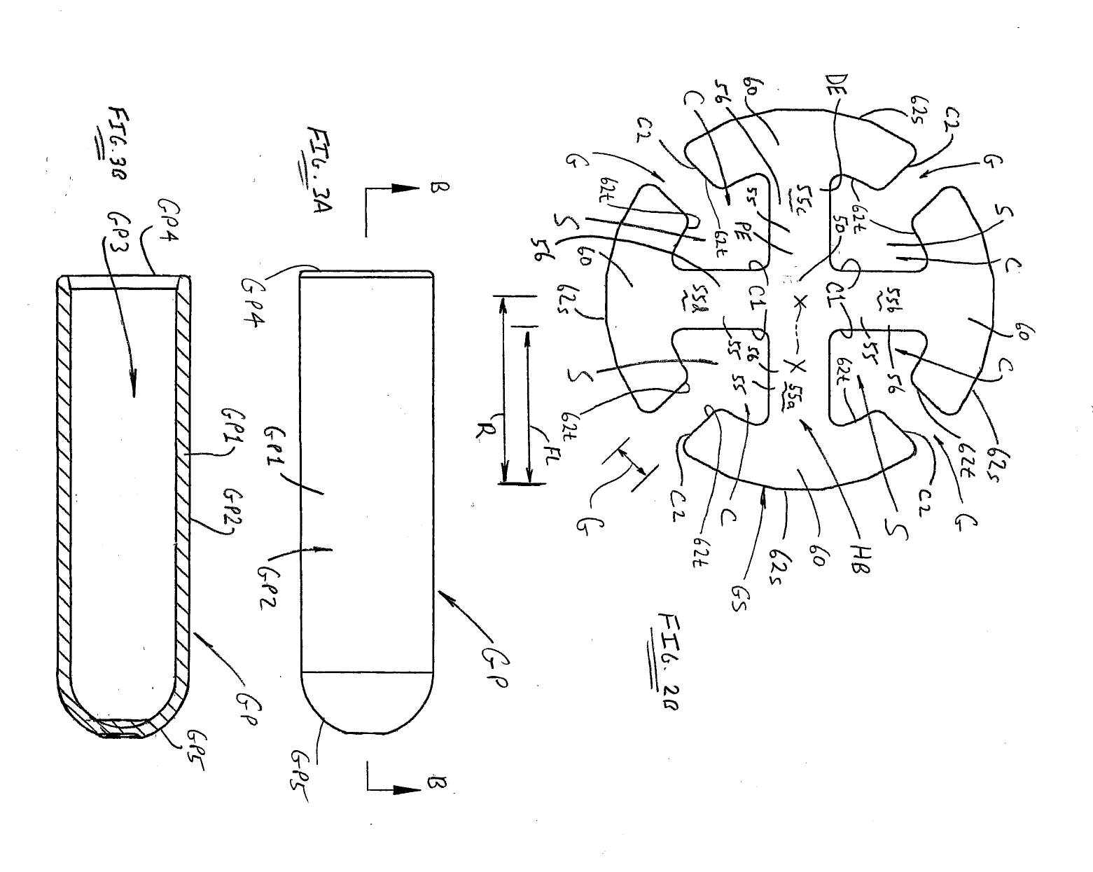

A hand grip GP (FIG. 2) is connected to the outer end H2 of the handle H to provide a safe and comfortable surface for a user's hands to grasp the outer end H2 of the handle H when sweeping or performing other work with a tool connected to the tip T. For added institutional safety, the hand grip GP is preferably defined from a suitable soft, smooth, low-density “shank-free” polymer such as polyurethane that resists formation into a sharp instrument or “shank” if sanded, abraded or otherwise mechanically shaped. Also, the hand grip GP is preferably permanently connected to the handle body HB using an adhesive or other suitable means so that a user cannot remove the hand grip GP from the handle H. FIG. 3A is a side view of a polymeric hand grip portion of the handle of FIG. 2, and FIG. 3B is a section view of the hand grip of FIG. 3A as taken at B-B of FIG. 3A. The hand grip comprises a one-piece molded polymeric structure comprising a cylindrical tubular body GP1 that comprises a cylindrical outer surface GP2 and a cylindrical central bore GP3. The central bore GP3 opens through a first end GP4 of the body GP1, and an opposite second end of the body GP1 is closed by an end wall GP5 that is preferably convexly curved to provide a smooth comfortable surface for pushing by a user's hand. The hand grip GP is installed on the outer end H2 of the handle body HB by inserting the second end H2 of the handle body HB into the central bore GP3 of the grip GP1 through the open first end GP4. The end wall GP5 covers the outer second end HB2 of the handle body HB. The handle grip GP is preferably permanently connected to the handle body HB using an adhesive.

The present development has been described with reference to preferred embodiments. Modifications and alterations will occur to those of ordinary skill in the art to which the invention pertains, and it is intended that the claims be construed as broadly as possible to encompass all such modifications and alterations while preserving the validity of the claims.

1. A handle for a push broom or other janitorial tool, said handle comprising:
an elongated body including opposite first and second ends, said body comprising a polymeric structure comprising:
a core that extends along a longitudinal axis;
a plurality of arms that extend radially outward from the core, each of said arms comprising an inner end connected to the core and an outer end comprising an enlarged head including an outer surface for being gripped by a user, the outer surfaces of the arms together defining a gripping surface;
wherein each circumferentially successive pair of arms is circumferentially spaced-apart from each other by an open channel that extends parallel to the longitudinal axis, each of said open channels comprising a space defined between said circumferentially successive pair of arms and comprising a gap in communication with the space and that separates circumferentially successive enlarged heads from each other such that said gap interrupts said gripping surface.

2. The handle as set forth in claim 1, wherein said handle body comprises a one-piece structure.

3. The handle as set forth in claim 2, wherein said handle body comprises an extrusion with a uniform profile that extends continuously between said first and second ends.

4. The handle as set forth in claim 2, wherein each of said enlarged heads comprises a convex outer surface.

5. The handle as set forth in claim 4, wherein said convex outer surface of each enlarged head comprises a curved surface.

6. The handle as set forth in claim 1, wherein said handle body comprises four arms symmetrically arranged about said core and angularly spaced-apart from each other in 90 degree increments.

7. The handle as set forth in claim 1, wherein said core comprises a solid structure.

8. The handle as set forth in claim 1, wherein each arm comprises first and second connecting surfaces that connect opposite circumferential ends of the outer surface of the enlarged head to said outer end of said arm.

9. The handle as set forth in claim 3, wherein each of said enlarged heads comprises a convex outer surface.

10. The handle as set forth in claim 9, wherein said convex outer surface of each enlarged head comprises a curved surface.

11. The handle as set forth in claim 1, wherein a maximum angular dimension of each gap G is less than the maximum angular spacing between circumferentially successive arms.

12. The handle as set forth in claim 1, wherein each arm defines a maximum radial free length measured from a location where said arm connects with said core, and wherein said maximum radial free length is at least 50% of a maximum radius of the handle body.

13. The handle as set forth in claim 3, wherein said handle body comprises four arms symmetrically arranged about said core and angularly spaced-apart from each other in 90 degree increments.

14. The handle as set forth in claim 13, wherein said core comprises a solid structure.

15. The handle as set forth in claim 6, wherein each arm comprises first and second connecting surfaces that connect opposite circumferential ends of the outer surface of the enlarged head of said arm to said outer end of said arm.

16. The handle as set forth in claim 3, wherein a maximum angular dimension of each gap G is less than the maximum angular spacing between circumferentially successive arms.

17. The handle as set forth in claim 16, wherein each arm defines a maximum radial free length measured from a location where said arm connects with said core, and wherein said maximum radial free length is at least 50% of a maximum radius of the handle body.

18. The handle as set forth in claim 3, wherein each arm defines a maximum radial free length measured from a location where said arm connects with said core, and wherein said maximum radial free length is at least 50% of a maximum radius of the handle body.

19. The handle as set forth in claim 1, further comprising a tip secured to said first end of said handle body, said tip adapted to be connected to a push broom or other janitorial tool.

20. The handle as set forth in claim 19, further comprising a hand grip secured to said second end of said handle body, said hand grip comprising a one-piece tubular polymeric structure comprising a closed end that covers said second end of said handle body.
